(19) United States
(12) Patent Application Publication
(10) Pub. No.: US 2026/0263997 A1
(43) Pub. Date: Sep. 10, 2026

(54) OXYGEN CONCENTRATOR ASSEMBLED WITH QUICK-DETACH MOLECULAR SIEVE

(71) Applicant: QINGDAO AUGREENER ELECTRONIC TECHNOLOGY CO., LTD, Shandong (CN)

(72) Inventor: Yu DONG, Shandong (CN)

(21) Appl. No.: 19/657,510

(22) Filed: Apr. 24, 2026

Related U.S. Application Data
(63) Continuation-in-part of application No. PCT/CN2025/105470, filed on Jun. 30, 2025.

(30) Foreign Application Priority Data
Jan. 17, 2025 (CN) 202510074041.3

(51) Int. Cl. B01D 53/22; C01B 13/02

(52) U.S. Cl. CPC B01D 53/22; C01B 13/0251; B01D 2053/221; B01D 2256/12; C01B 2210/0048

(57) ABSTRACT

An oxygen concentrator assembled with a quick-detach molecular sieve. The concentrator includes a main body and a molecular sieve module. A quick-detach docking port is formed on one side of the main body. An air inlet port, an oxygen port, and a guide wedge surface are integrated at a portion of the quick-detach docking port near a top, and the air inlet port, oxygen port, and guide wedge surface project outwardly. A molecular sieve air inlet connector, a molecular sieve oxygen connector, and a guide mating surface are disposed at a portion of the molecular sieve module near a top. The air inlet connector is inserted into the air inlet port, and the oxygen connector is inserted into the oxygen port. The sieve module is assembled to the quick-detach docking port by guided fitting between the guide mating surface and the guide wedge surface along an insertion direction.

### CROSS REFERENCE TO RELATED APPLICATIONS

The present application is a continuation-in-part of PCT/CN2025/105470, filed Jun. 30, 2025, not yet published, which claims priority to Chinese Patent Application No. CN 202510074041.3, filed Jan. 17, 2025, the entire contents of each are incorporated herein by reference.

### BACKGROUND

The present application belongs to the field of oxygen concentrators, and particularly relates to an oxygen concentrator assembled with a quick-detach molecular sieve.

A molecular sieve-type oxygen concentrator is a device that uses adsorption properties of molecular sieves to separate and produce high-purity oxygen from the air. A structure thereof mainly includes an air compression assembly, a molecular sieve assembly, and an oxygen storage assembly. Air is filtered and compressed by the air compression assembly and then enters the molecular sieve assembly with a double molecular sieve cylinder structure. The air is evenly distributed through a gas distribution valve and enters one of the molecular sieve cylinders provided with a molecular sieve. Nitrogen, carbon dioxide, and other gases in the air are adsorbed, and the outflowing gas is the high-purity oxygen. When an adsorption tower reaches a certain saturation level, the gas distribution valve closes the inlet of the air for backflushing and cleaning, and the adsorption tower enters a purging stage to discharge waste, and the other molecular sieve cylinder provided with a molecular sieve begins to work, and the above cycle repeats continuously to provide oxygen.

While oxygen concentrators are currently applied to the medical field, they are also gradually entering the household and outdoor fields. For example, when people go to places like plateaus to appreciate the unique scenery of nature, they may experience adverse symptoms such as altitude sickness when moving from a low altitude to a high altitude. In such cases, an oxygen concentrator is needed to help providing necessary oxygen to the body.

With oxygen concentrators becoming fully consumer-grade products are being used in households and outdoors, molecular sieves, as consumables, will experience a decrease in oxygen production efficiency over time, affecting user experience. Therefore, regular replacement of molecular sieves is necessary. In existing traditional oxygen concentrators, a molecular sieve cylinder is integrated with other components, resulting in a complex structure that is difficult for users to replace the molecular sieve by themselves. Typically, the oxygen concentrator needs to be returned to the factory for professional handling. However, returning the oxygen concentrator to the factory increases both a use-cost of the user and a workload of after-sales staff.

To reduce the workload of after-sales staff, CN221788737U discloses an oxygen concentrator layout structure, including a rear shell, a front shell, an upper shell, a base, a compressor, a compressor cover, an inlet silencer, an exhaust silencer, a molecular sieve cylinder, a fixed bracket, and an oxygen tank. The rear shell, front shell, upper shell, and base are combined to form an outer shell of the oxygen concentrator. The rear shell and compressor cover are fixedly disposed on the base. The fixed bracket, a cooling fan, and the molecular sieve cylinder are disposed on a top of the compressor cover. The cooling fan is disposed below the fixed bracket. The oxygen tank, exhaust silencer, and a two-position four-way valve are disposed above the fixed bracket. The molecular sieve cylinder is fixed to a side plate of the fixed bracket by a quick-detach structure. The compressor and exhaust silencer are disposed inside the compressor cover, and the inlet silencer is disposed on a side surface of the compressor cover. An air inlet is disposed on the rear shell, and an inlet air path guide is disposed on an inner side of the rear shell to cover the corresponding air inlet. A humidification bottle is disposed on the upper shell. This solution reduces difficulty for staff to disassemble and assemble the molecular sieve cylinder by replacing the entire cylinder. However, since the molecular sieve cylinder is closely connected to other components, it is difficult for a user to disassemble the molecular sieve cylinder by themselves, and returning the oxygen concentrator to the factory for repair will still increase the use-cost of the user. Therefore, providing a reasonably designed oxygen concentrator that allows a user to quickly detach and assemble a molecular sieve cylinder is a problem that an exemplary aspect of the present disclosure urgently needs to solve.

It should be noted that the information disclosed in the background section of this disclosure is intended only to enhance the understanding of the general background of the present disclosure, and should not be construed as an admission or in any way implying that the information constitutes prior art known to those skilled in the art.

### SUMMARY

An exemplary aspect of the present application provides an oxygen concentrator assembled with a quick-detach molecular sieve, the oxygen concentrator including: an oxygen concentrator main body having a quick-detach docking port formed on one side thereof, and an air inlet port, an oxygen port, and a guide wedge surface being integrated at a portion of the quick-detach docking port near a top, and the air inlet port, the oxygen port, and the guide wedge surface being disposed in a manner of projecting outward; and
a molecular sieve module provided with a molecular sieve air inlet connector, a molecular sieve oxygen connector, and a guide mating surface disposed at a portion of the molecular sieve module near a top, in which
the molecular sieve module is assembled to the quick-detach docking port of the oxygen concentrator main body by guided fitting between the guide mating surface and the guide wedge surface along an insertion direction, and
the molecular sieve air inlet connector is correspondingly inserted into the air inlet port, and the molecular sieve oxygen connector is correspondingly inserted into the oxygen port.

Preferably, the oxygen concentrator main body includes a main body case, and an air compression assembly, an oxygen storage assembly, a sensing assembly, and a control assembly disposed within the main body case,
the main body case includes an upper bracket, a lower bracket, a side plate, and a panel, and
the upper bracket and the lower bracket are disposed in different layers, the side plate encloses the upper bracket and the lower bracket and forms the quick-detach docking port on a side of the main body case, the panel is positioned above the side plate, and the air inlet port, the oxygen port, and the guide wedge surface are disposed on the upper bracket.

Preferably, the upper bracket is further provided with a first integrated docking support base, and two air inlet ports and one oxygen port are disposed on the first integrated docking support base.

Preferably, the upper bracket includes a first bracket segment having a high relative elevation, a second bracket segment having a low relative elevation, and a connecting segment that connects the first bracket segment and the second bracket segment, and
the first bracket segment extends over the quick-detach docking port, an accommodating space is formed below the first bracket segment, and the first integrated docking support base and the guide wedge surface are disposed on the first bracket segment.

Preferably, the connecting segment includes one strip plate and two arc-shaped plates which are integrally formed, the strip plate is disposed between the two arc-shaped plates, and each of the arc-shaped plates has a first fitting concave surface facing the accommodating space.

Preferably, the second bracket segment is provided with a gas distribution valve, the gas distribution valve includes a gas distribution valve body and a mounting base, the mounting base is assembled and fixed to the strip plate, the mounting base has a second fitting concave surface that fits a convex surface of the arc-shaped plate, an air inlet of the gas distribution valve body is in communication with the air compression assembly, and an air outlet thereof is in communication with the air inlet port.

Preferably, the mounting base has a chamber in communication with a nitrogen discharge port of the gas distribution valve body, and a bottom of the mounting base is also provided with a nitrogen discharge pipe in communication with the chamber, and the second bracket segment is provided with a nitrogen discharge insertion hole, and the nitrogen discharge pipe is inserted into the nitrogen discharge insertion hole.

Preferably, the second bracket segment is further provided with a limiting slot, and a bottom of the gas distribution valve body is provided with a limiting plate which is correspondingly inserted into and limited by the limiting slot.

Preferably, the molecular sieve module includes an upper sieve lid, a lower sieve base, and two molecular sieve cylinders,
the molecular sieve cylinders are disposed between the upper sieve lid and the lower sieve base and positioned in the accommodating space, and the molecular sieve cylinders fit the first fitting concave surfaces, and
the molecular sieve air inlet connector, the molecular sieve oxygen connector, and the guide mating surface are provided on the upper sieve lid, and the molecular sieve air inlet connector and the molecular sieve oxygen connector are respectively in communication with an air inlet channel and an oxygen outlet channel of each of the molecular sieve cylinders.

Preferably, the upper bracket is further provided with a positioning slot at a portion facing the upper sieve lid, and the upper sieve lid is formed with at least one positioning insertion portion inserted into the positioning slot.

Preferably, the upper sieve lid is provided with a second integrated docking support base, and two molecular sieve air inlet connectors and one molecular sieve oxygen connector are disposed on the second integrated docking support base.

Preferably, the oxygen outlet channel of the molecular sieve cylinder is positioned at a bottom, the lower sieve base is provided with a pressure equalization valve, and the oxygen outlet channel is in communication with the molecular sieve oxygen connector through the pressure equalization valve.

Preferably, the upper sieve lid is further provided with a gas guide extension pipe, the gas guide extension pipe has one end in communication with the molecular sieve oxygen connector, and has the other end extending and suspended outside the molecular sieve cylinders and in communication with the pressure equalization valve through a flexible hose.

Preferably, the guide mating surface is implemented as a side surface of the gas guide extension pipe.

Preferably, the molecular sieve module further includes a molecular sieve shell, and the molecular sieve shell includes a first shell, a second shell, and an air inlet grille,
the air inlet grille is assembled between the first shell and the second shell, and
the air inlet grille allows air to enter the air compression assembly at least through the quick-detach docking port.

Preferably, an air inlet filter is disposed on an inner side and/or an outer side of the air inlet grille.

Preferably, the first integrated docking support base is provided with a first assembly hole, the second integrated docking support base is provided with a second assembly hole, the molecular sieve shell is provided with a third assembly hole, and the first assembly hole, the second assembly hole, and the third assembly hole are each assembled by a screw passing therethrough.

Preferably, the lower bracket is provided with a heat dissipation port at a portion facing the quick-detach docking port, and the heat dissipation port faces the molecular sieve cylinder.

Preferably, the panel is suspended and extends above the quick-detach docking port, and the molecular sieve module is hidden below the panel.

Preferably, the control assembly is a control mainboard, and the sensing assembly includes an oxygen concentration sensor, a respiration sensor, and a pressure sensor disposed on the control mainboard, and
the control mainboard is disposed on the upper bracket and/or the lower bracket along a stacking direction of the upper bracket and the lower bracket.

Preferably, the upper bracket is formed with a first mounting region, the lower bracket is formed with a second mounting region, at least the oxygen storage assembly is disposed in the first mounting region, and the air compression assembly is disposed in the second mounting region,
the respiration sensor and the pressure sensor are positioned in or face the first mounting region, and
the oxygen concentration sensor is positioned on a side of the control mainboard opposite the first mounting region, and an oxygen inlet pipe and an oxygen outlet pipe of the oxygen concentration sensor extend over the first mounting region.

The present application provides an oxygen concentrator including an oxygen concentrator main body and a molecular sieve module that are assembled in a detachable manner.

The oxygen concentrator main body includes a first shell portion, a panel, and a main body connector portion. The first shell portion is a portion including an upper bracket, a lower bracket, and a side plate, which is a part of a main body case.

The first shell portion encloses to form a space capable of accommodating an air compression assembly, and is formed with a first assembly side portion on a side close to the molecular sieve module. The first assembly side portion is a portion that limits and forms a quick-detach docking port.

The panel covers and is connected to one end of the first shell portion and has a suspended extending portion that projects toward the molecular sieve module relative to the first assembly side portion. The suspended extending portion is a portion of the panel that is suspended and extends over the quick-detach docking port.

The main body connector portion is disposed between the suspended extending portion and the first assembly side portion, and has an air inlet port and an oxygen port.

The molecular sieve module includes a second shell portion and a molecular sieve connector portion. The second shell portion may be a molecular sieve shell.

The second shell portion encloses to form a space capable of accommodating a molecular sieve cylinder, and is formed with a second assembly side portion on a side close to the oxygen concentrator main body, and has one end formed with an opening. The second assembly side portion is a portion that mates with a docking socket.

The molecular sieve connector portion is positioned within the space enclosed by the second shell portion, and has a molecular sieve air inlet connector and a molecular sieve oxygen connector.

In an assembled state of the oxygen concentrator main body and the molecular sieve module, the first assembly side portion and the second assembly side portion are connected to each other, the suspended extending portion covers the opening, the molecular sieve air inlet connector is correspondingly inserted into the air inlet port, and the molecular sieve oxygen connector is correspondingly inserted into the oxygen port.

The technical effects achieved by one or more embodiment of the present application arise from one or more of the following combinations.

The present application enables rapid detachment and assembly of the molecular sieve module from and to the oxygen concentrator main body via the quick-detach docking port, making molecular sieve replacement in the oxygen concentrator more convenient and efficient. There is no need for complex detachment process, and simply replacing the entire molecular sieve module can achieve the replacement of the molecular sieve, thus improving replacement efficiency of the molecular sieve. By fitting movement between the guide wedge surface of the oxygen concentrator main body and a mating wedge face of the molecular sieve module, quick alignment between the air inlet port and the molecular sieve air inlet connector and between the oxygen port and the molecular sieve oxygen connector is achieved. Docking is performed using a pluggable assembly method, so as to shorten a replacement time of the molecular sieve module, improve user convenience in replacement, and enhance an overall integration level of the oxygen concentrator, making the device more compact and aesthetically pleasing.

A unique mounting structure is designed, in which the upper bracket is set as a staggered structure with high and low spaces. The molecular sieve cylinder is accommodated below the relatively high first bracket segment, and the gas distribution valve is disposed on the relatively low second bracket segment, so as to achieve a compact structural design, improve a space utilization rate, and facilitate the replacement and docking of the molecular sieve cylinder as a whole module.

The interfaces of the oxygen concentrator main body and the molecular sieve module, along with the gas distribution valve, are integrated into one area for convenient and efficient docking.

The specific design of the upper bracket, combined with the structures of the mounting valve base and the molecular sieve cylinders, ensures a tight fit between the molecular sieve cylinders, the upper bracket, and the gas distribution valve, further enhancing stability and ease of assembly of the device.

The gas distribution valve body is mounted on the connecting segment by the mounting valve base, and the bottom thereof is inserted into and limited by the second bracket segment. The mounting is carried out by positioning first and then assembling, which is stable and simple.

The nitrogen discharge insertion hole on the second bracket segment is for inserting the nitrogen discharge pipe of the mounting valve base, so that the exhaust gas of the gas distribution valve body can be discharged by this structure to a part below the upper bracket and then discharged to the outside of the oxygen concentrator. The nitrogen discharge insertion hole has the function of discharging nitrogen, and also enables mounting of the mounting valve base through the nitrogen discharge pipe.

By designing the molecular sieve shell and the molecular sieve cylinder into a modular structure, it is convenient for users to quickly perform replacement, thereby reducing a downtime and a maintenance cost of the oxygen concentrator and extending a service life thereof. Moreover, the molecular sieve shell is hidden under the panel, making the overall structure more aesthetically pleasing and integrated.

The modular design allows for quick detachment and mounting of the molecular sieve cylinders. By mounting the molecular sieve shell entirely in an assembly way, and after the assembly, fixing the molecular sieve shell via the slot, the overall detachment and assembly is facilitated.

To improve the ease of replacement of the molecular sieve:

The molecular sieve module is designed with a quick-plug interface, making it easy for users to perform replacement or maintenance quickly.

To extend the service life of the device:

The independent modular design ensures that the molecular sieve can be replaced in a timely manner, avoiding the overall device failure caused by the failure of the molecular sieve in a purely integrated design.

To improve maintenance efficiency:

Quick docking and detachment simplify the maintenance process and reduce the maintenance cost of users.

### BRIEF DESCRIPTION OF THE SEVERAL VIEWS OF THE DRAWINGS

FIG. 1 illustrates a schematic diagram of the present application;

FIG. 2 illustrates an assembly schematic diagram of a molecular sieve module of an oxygen concentrator main body in the present application;

FIG. 3 illustrates a schematic diagram of the oxygen concentrator main body in the present application;

FIG. 4 illustrates a schematic diagram of a main body case in the present application;

FIG. 5 illustrates a docking diagram between the molecular sieve module and the oxygen concentrator main body in the present application;

FIG. 6 illustrates a mounting schematic diagram of a sensing assembly in the present application;

FIG. 7 illustrates a schematic diagram of a back side of the present application;

FIG. 8 illustrates an assembly schematic diagram of an upper sieve lid and an upper bracket in the present application;

FIG. 9 illustrates a mounting position of a gas distribution valve in the present application;

FIG. 10 illustrates a schematic diagram of the disassembled molecular sieve module and upper bracket in the present application;

FIG. 11 illustrates a schematic diagram of the disassembled molecular sieve module and upper bracket from another perspective in the present application;

FIG. 12 illustrates a mounting schematic diagram of a mounting valve base and the upper bracket in the present application;

FIG. 13 illustrates a mounting exploded diagram of the gas distribution valve and the upper bracket in the present application;

FIG. 14 illustrates a schematic diagram of a gas distribution valve body and the mounting valve base in the present application;

FIG. 15 illustrates a schematic diagram of a molecular sieve shell in the present application;

FIG. 16 illustrates an assembly diagram of an air inlet grille and a first shell in the present application;

FIG. 17 illustrates an assembly diagram of a second shell and the first shell in the present application; and

FIG. 18 illustrates a schematic diagram of an oxygen concentrator in the present application.

Reference numerals: oxygen concentrator main body 1, quick-detach docking port 10, main body case 11, upper bracket 111, guide wedge surface 1110, first bracket segment 1111, second bracket segment 1112, nitrogen discharge insertion hole 11120, mounting region 11121, limiting slot 11122, nitrogen discharge insertion hole 11123, connecting segment 1113, strip plate 11131, first fitting concave surface 11130, arc-shaped plate 11132, first mounting hole 11133, positioning slot 1114, fan mounting port 1115, lower bracket 112, heat dissipation port 1120, side plate 113, heat dissipation outlet 1130, panel 114, first mounting region 115, second mounting region 116, first integrated docking support base 12, first assembly hole 120, air inlet port 121, oxygen port 122, gas distribution valve 13, gas distribution valve body 131, air inlet 1310, air outlet 1311, limiting plate 1312, third mounting hole 1313, mounting valve base 132, chamber 1320, nitrogen discharge pipe 1321, second fitting concave surface 1322, second mounting hole 1323, fourth mounting hole 1324, air compression assembly 14, oxygen storage assembly 15, sensing assembly 16, respiration sensor 161, pressure sensor 162, oxygen concentration sensor 163, oxygen inlet pipe 1631, oxygen outlet pipe 1632, control assembly 17, battery 18, oxygen injection valve 19, molecular sieve module 2, molecular sieve shell 21, first shell 211, first shell assembly hole 2110, first bottom plate 2111, first docking edge slot 21110, first clamping slot 21111, first docking slot 21112, first vertical plate 2112, second shell 212, second shell assembly hole 2120, second lug 2121, second docking portion 2122, air inlet grille 213, air inlet grille assembly hole 2130, air inlet grille lug (third assembly hole) 2131, first docking portion 2132, upper sieve lid 22, first lug 221, lower sieve base 23, pressure equalization valve 230, molecular sieve cylinder 24, second integrated docking support base 25, second assembly hole 250, molecular sieve air inlet connector 251, molecular sieve oxygen connector 252, gas guide extension pipe 26, guide mating surface 260, oxygen concentrator main body 901, first shell portion 911, first assembly side portion 9110, panel 912, suspended extending portion 9120, main body connector portion 913, air inlet port 9131, oxygen port 9132, molecular sieve module 902, second shell portion 921, second assembly side portion 9210, opening 922, molecular sieve connector portion 923, molecular sieve air inlet connector 9231, molecular sieve oxygen connector 9232.

### DETAILED DESCRIPTION OF THE DISCLOSURE

The following description is provided to enable those skilled in the art to implement and use the present application and apply the present application to specific application contexts. Various variations and uses in different applications will be readily apparent to those skilled in the art, and the general principles defined herein are applicable to a wide range of embodiments. Therefore, the present application is not limited to the embodiments given herein, but should be granted a broadest scope consistent with the principles and novelties disclosed herein.

In the following detailed description, numerous specific details are set forth to provide a more thorough understanding of the present application. However, it will be apparent to those skilled in the art that the practice of the present application is not necessarily limited to these specific details. In other words, well-known structures and devices are shown in block diagram form without detailed description for avoiding obscuring the present application.

Readers should note all documents and literatures submitted concurrently with the present specification and made publicly available, and the contents of all such documents and references are incorporated herein by reference. Unless otherwise stated directly, all features disclosed in the present specification (including any appended claims, abstract and drawings) may be replaced by alternative features for the same, equivalent or similar purpose. Therefore, unless otherwise explicitly stated, each feature disclosed is merely an example of a set of equivalent or similar features.

Note that, when used, the markings left, right, front, rear, top, bottom, forward, backward, clockwise, and counterclockwise are used for convenience only and do not imply any specific fixed direction. In fact, they are used to reflect the relative positions and/or orientations between various parts of an object. Furthermore, the terms “first” and “second” are used for descriptive purposes only and should not be construed as indicating or implying relative importance.

In the description of the present application, it should be noted that, unless otherwise expressly specified and limited, the terms “mount”, “connected”, and “connect” should be interpreted broadly, for example, as a fixed connection, a detachable connection, or an integral connection; as a mechanical connection; as a direct connection or an indirect connection through an intermediate medium; or as a communication within two elements. Those skilled in the art can understand the specific meaning of the above terms in the present application based on the specific circumstances.

Note that, when used, “further”, “preferably”, “still further”, and “more preferably” are simply starts for describing another embodiment based on the foregoing embodiments, and the content following “further”, “preferably”, “still further”, or “more preferably” combined with the foregoing embodiments constitutes a complete structure of another embodiment. Another embodiment may be formed by any combination of several further, preferable, still further or more preferable configurations following the same embodiment.

The present application will now be described in detail with reference to the accompanying drawings and specific embodiments. Note that the aspects described below in conjunction with the accompanying drawings and specific embodiments are merely exemplary and should not be construed as limiting the scope of the present application in any way.

It should be noted that an oxygen concentrator is a device that physically separates oxygen using molecular sieves. The principle thereof is as follows. First, inlet air of the device is filtered and compressed by an air compression assembly, and then gas is distributed into a molecular sieve assembly by a gas distribution valve. The molecular sieve assembly includes two molecular sieve cylinders, which work alternately. The gas distribution valve passes the compressed gas into one of the molecular sieve cylinders. Based on different adsorption capacities of the molecular sieve for nitrogen and oxygen, nitrogen is adsorbed and oxygen is discharged, and then oxygen enters an oxygen storage tank. After working for a period of time, the gas distribution valve alternates to allow the other molecular sieve cylinder to work, and an adsorption tower of the previous molecular sieve is backflushed to discharge nitrogen, and the above processing is repeated alternately. This is a necessary prerequisite for understanding the solution in some embodiments.

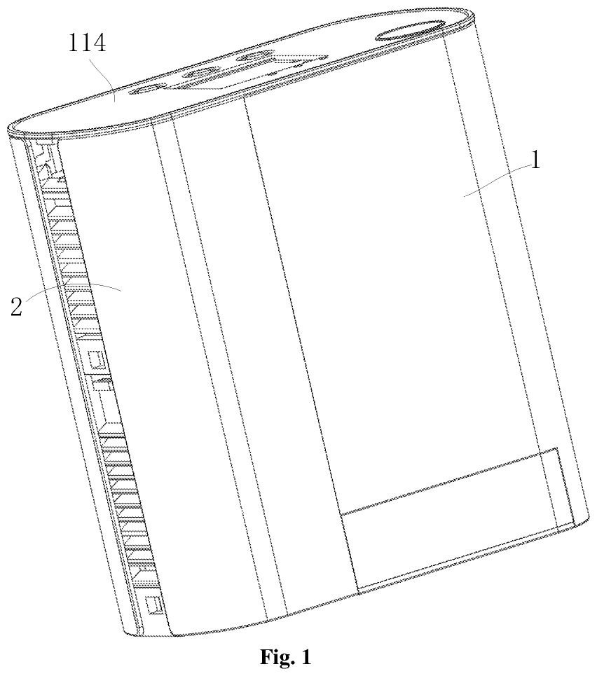

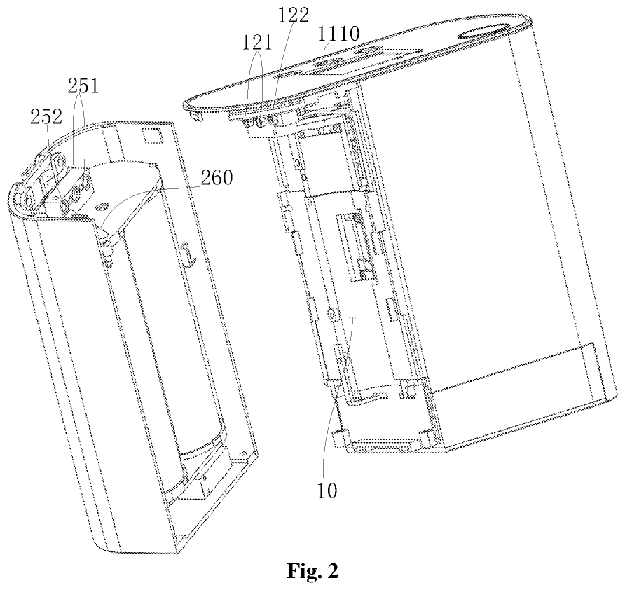

With reference to FIGS. 1 to 3, an oxygen concentrator assembled with a quick-detach molecular sieve mainly includes two core parts, that is, an oxygen concentrator main body 1 and a molecular sieve module 2. An object thereof is to integrate a gas docking structure at a position near a top through a modular design of the molecular sieve, and in conjunction with a positioning guide structure, the molecular sieve can be quickly detached from the oxygen concentrator main body 1 and replaced. Specifically, with reference to FIG. 2, the oxygen concentrator main body 1 has a quick-detach docking port 10 formed on one side thereof, air inlet ports 121, an oxygen port 122, and a guide wedge surface 1110 are integrated at a portion of the quick-detach docking port 10 near a top, and the air inlet ports 121, the oxygen port 122, and the guide wedge surface 1110 are disposed in a manner of projecting outward. The molecular sieve module 2 has molecular sieve air inlet connectors 251, a molecular sieve oxygen connector 252, and a guide mating surface 260 disposed at a portion near a top. The molecular sieve air inlet connectors 251 are correspondingly inserted into the air inlet ports 121, and the molecular sieve oxygen connector 252 is correspondingly inserted into the oxygen port 122. The molecular sieve module 2 is assembled to the quick-detach docking port 10 of the oxygen concentrator main body 1 by guided fitting between the guide mating surface 260 and the guide wedge surface 1110 along an insertion direction.

In some embodiments, the guide wedge surface 1110 and the guide mating surface 260 can be implemented as a groove and a slider, as two inclined faces fitting each other, or the like, in order to guide and position the insertion of the molecular sieve module 2 to the oxygen concentrator main body 1.

For the oxygen concentrator main body 1, a core change thereof is to integrate the air inlet ports 121, the oxygen port 122 and the guide wedge surface 1110 into a region near the top, thereby achieving a high integration level. The oxygen concentrator main body 1 of a typical oxygen concentrator on the market can also be modified according to the description of some embodiments to achieve the above effects. For further description, some embodiments specifically provide the oxygen concentrator main body 1, but are not limited thereto.

Oxygen Concentrator Main Body 1:

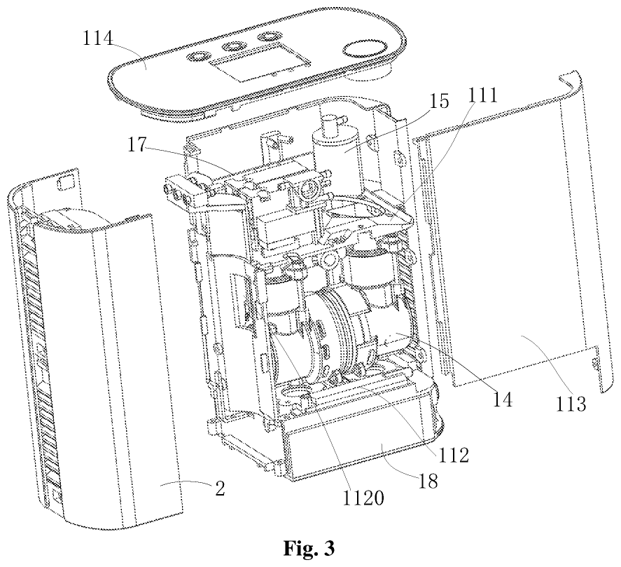

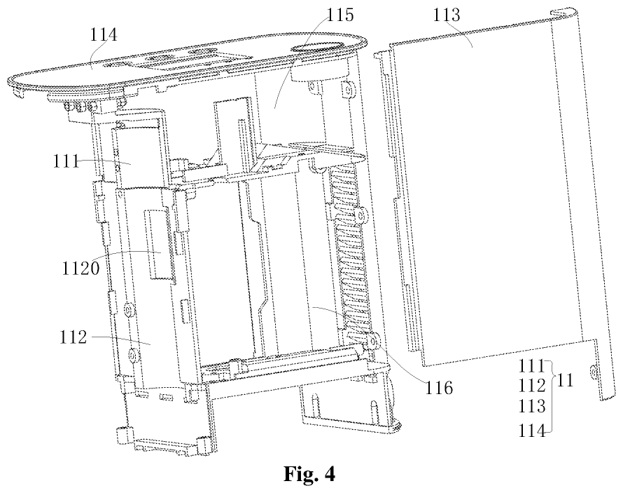

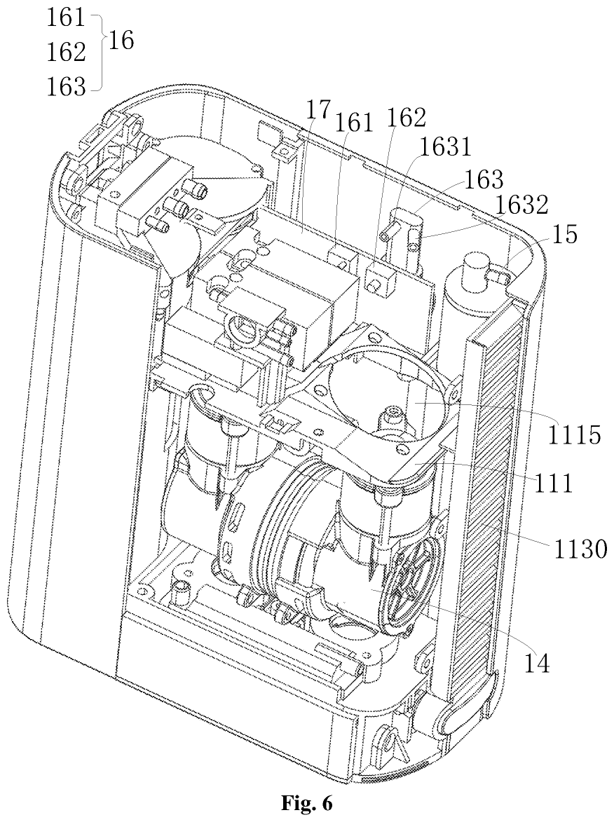

With reference to FIGS. 3 and 4, as exemplary embodiments, the oxygen concentrator main body 1 includes a main body case 11, an air compression assembly 14, an oxygen storage assembly 15, a sensing assembly 16 (see FIG. 6), and a control assembly 17. As a structural load-bearing component, the entire main body case 11 is made of plastic or metal. The air compression assembly 14, oxygen storage assembly 15, sensing assembly 16, and control assembly 17 are all disposed inside the main body case 11.

Furthermore, with reference to FIGS. 1, 3, and 4, the main body case 11 includes an upper bracket 111, a lower bracket 112, a side plate 113, and a panel 114. Specifically, the upper bracket 111 and the lower bracket 112 are disposed in different layers. The side plate 113 encloses the upper bracket 111 and the lower bracket 112 and is formed with a quick-detach docking port 10 on a side portion of the main body case 11. The panel 114 is positioned above the side plate 113. Air inlet ports 121, an oxygen port 122, and a guide wedge surface 1110 are provided on the upper bracket 111. The side plate 113 encloses the upper bracket 111 and the lower bracket 112 and is formed with the aforementioned quick-detach docking port 10 on one side, facilitating the assembly and mounting of the molecular sieve module 2 to the upper bracket 111 or the lower bracket 112. The panel 114 is suspended and extends above the quick-detach docking port 10, and the molecular sieve module 2 is hidden below the panel 114.

In some embodiments, with reference to FIG. 6, the control assembly 17 is a control mainboard, that is, an integrated circuit board, which serves as a control structure for the components in some embodiments. Furthermore, the sensing assembly 16 includes an oxygen concentration sensor 163, a respiration sensor 161, and a pressure sensor 162 disposed on the control mainboard, and the control mainboard is disposed on a side surface of the upper bracket 111 and/or the lower bracket 112 along a stacking direction of the upper bracket 111 and the lower bracket 112. Preferably, the control mainboard is disposed on side surfaces of the upper bracket 111 and the lower bracket 112 along the stacking direction of the upper bracket 111 and the lower bracket 112. Some embodiments also include a battery 18, which is common knowledge in a power supply structure for small household appliances and will not be described in detail here. The battery 18 is disposed at the bottom of the lower bracket 112.

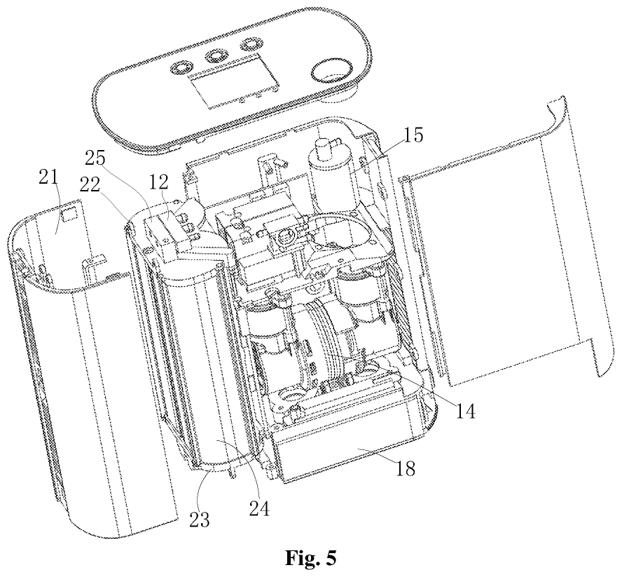

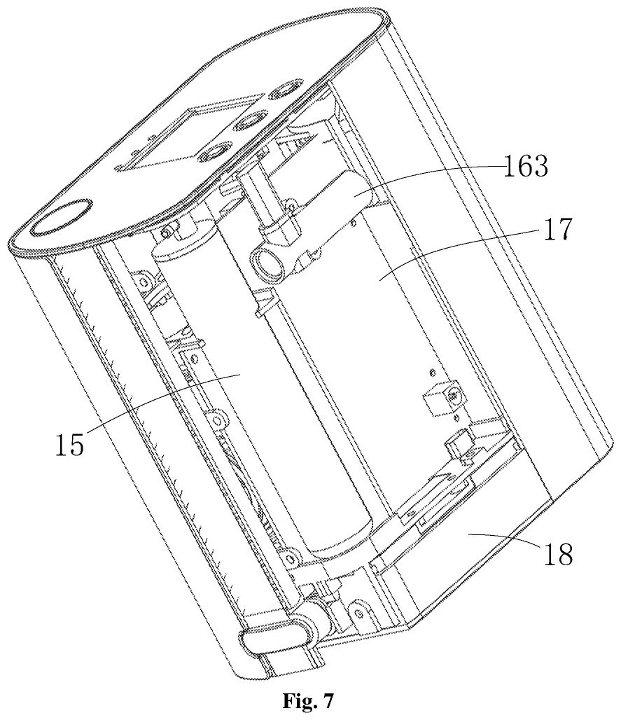

The upper bracket 111 and the lower bracket 112 serve as support structures, and are disposed in different layers. Specifically, with reference to FIGS. 4, 5, and 7, the upper bracket 111 is formed with a first mounting region 115, the lower bracket 112 is formed with a second mounting region 116. The oxygen storage assembly 15 is at least partially disposed in the first mounting region 115, and the air compression assembly 14 is disposed in the second mounting region 116. The respiration sensor 161 and the pressure sensor 162 are positioned in or face the first mounting region 115, and the oxygen concentration sensor 163 is positioned on a side of the control mainboard opposite the first mounting region 115, and an oxygen inlet pipe 1631 and an oxygen outlet pipe 1632 of the oxygen concentration sensor 163 extend into the first mounting region 115.

With reference to FIG. 6, the upper bracket 111 is also provided with a fan mounting port 1115 for mounting a fan that faces the air compression assembly 14 to blow air for cooling and heat dissipation. The side plate 113 is also provided with a heat dissipation outlet 1130.

The air compression assembly 14 is an air compressor, and a function thereof is to compresses the air entering the oxygen concentrator main body 1 and delivers the air directly or indirectly to the molecular sieve module 2 for physical separation of oxygen. The oxygen storage assembly 15 is an oxygen storage tank. After the oxygen is physically separated in the molecular sieve module 2, oxygen is directly or indirectly stored in the oxygen storage tank through the molecular sieve oxygen connector 252 which is docked with the oxygen port 122, and then transported to the outside. The indirect storage method includes storage after passing through an oxygen injection valve. Specifically, to make space layout more reasonable and improve a space utilization rate, an air inlet of the oxygen injection valve can be in communication with one end of the oxygen port 122. An air outlet is added at one end that is near the oxygen storage tank of the oxygen injection valve and is in communication with the oxygen storage tank. The air outlet and the air inlet of the oxygen injection valve are kept in a normally open state. Part of the oxygen output from the oxygen port 122 is transported to the oxygen storage tank through the oxygen injection valve.

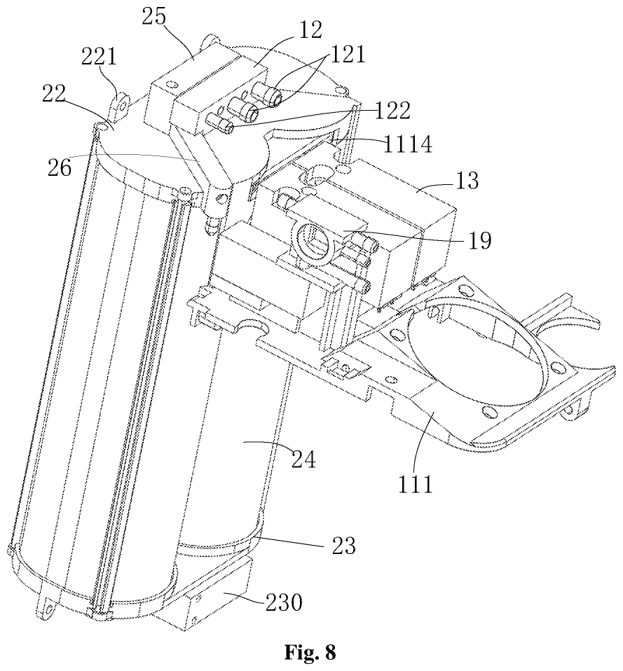

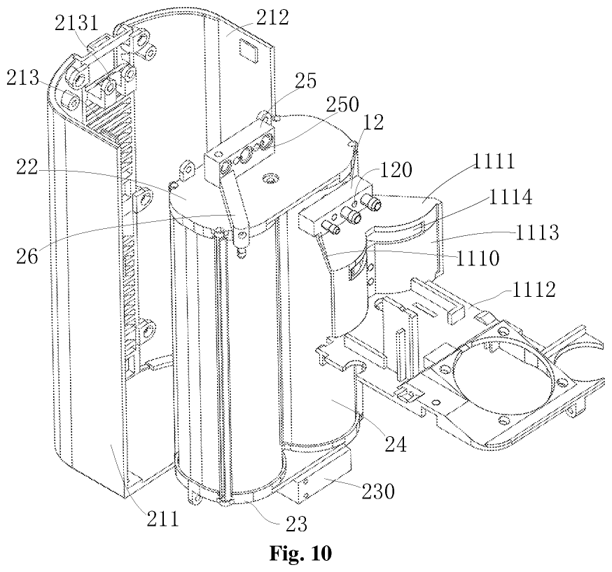

With reference to FIGS. 8 and 10, in some embodiments, the upper bracket 111 is also provided with a first integrated docking support base 12. The two air inlet ports 121 and one oxygen port 122 mentioned above are provided on the first integrated docking support base 12 to dock with the molecular sieve module 2. Similarly, the guide wedge surface 1110 is also preferentially provided on the upper bracket 111. Furthermore, in order to improve the space utilization rate for mounting the various components on the upper bracket 111, and to coordinate with the mounting of the molecular sieve module 2, the upper bracket 111 includes a first bracket segment 1111 having a high relative elevation, a second bracket segment 1112 having a low relative elevation, and a connecting segment 1113 that connects the first bracket segment 1111 and the second bracket segment 1112. The first bracket segment 1111 extends over the quick-detach docking port 10, an accommodating space is formed below the first bracket segment 1111, and the first integrated docking support base 12 and the guide wedge surface 1110 are disposed on the first bracket segment 1111. The first bracket segment 1111, the second bracket segment 1112, and the connecting segment 1113 can be implemented as a plate structure. This plate structure can be implemented as a flat plate, an irregularly shaped plate, or a curved plate. A side of the connecting segment 1113 facing the molecular sieve module 2 side is implemented as a first fitting concave surface 11130, a purpose of which is to adapt to a curved structure of the molecular sieve module 2.

To facilitate the docking of the first integrated docking support base 12 on the upper bracket 111 with the molecular sieve module 2, the guide wedge surface 1110 is implemented as a side surface of the first bracket segment 1111, and this side surface is implemented as an inclined face. Furthermore, a positioning slot 1114 is provided on the upper bracket 111 for engaging and positioning with the molecular sieve module 2.

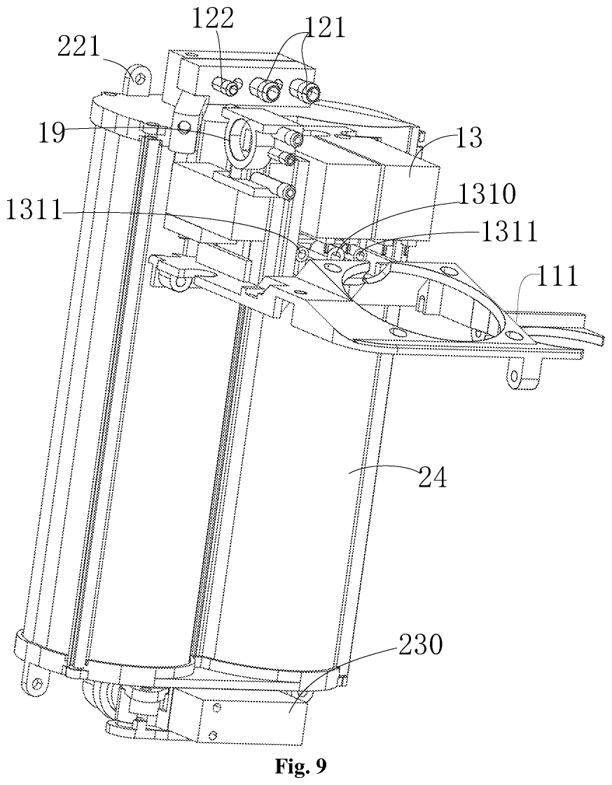

With reference to FIG. 9, a gas distribution valve 13 is provided on the second bracket segment 1112. An air inlet 1310 of the gas distribution valve 13 is in communication with the air compression assembly 14, and an air outlet 1311 thereof is in communication with the air inlet port 121, which has a function of gas distribution. Given the oxygen generation principle of the molecular sieve oxygen concentrator, the principle of the gas distribution valve 13 will not be further explained in some embodiments, and the gas distribution valve 13 is preferably a two-position four-way solenoid valve.

In some embodiments, the upper bracket serves as a structure mounting carrier for the gas distribution valve. The upper bracket has a stepped structure and is arranged in a staggered manner to improve the space utilization rate of the upper bracket. The gas distribution valve includes a gas distribution valve body 131 and a mounting valve base 132. The gas distribution valve body 131 and the mounting valve base 132 are assembled and connected and positioned on the second bracket segment 1112. The mounting valve base 132 is assembled and fixed to the upper bracket 111. Specifically, the mounting valve base 132 is assembled and fixed to the connecting segment 1113 of the upper bracket 111.

Furthermore, the connecting segment 1113 includes a strip plate 11131 and arc-shaped plates 11132 which are integrally formed. One strip plate 11131 is disposed between two arc-shaped plates 11132. The arc-shaped plate 11132 has the aforementioned first fitting concave surface 11130 facing the accommodating space. The molecular sieve cylinder 24 is fitted to the first fitting concave surface 11130. The mounting valve base 132 is assembled and fixed to the strip plate 11131. Correspondingly, the mounting valve base 132 has a second fitting concave surface 1322 that fits a convex surface of the arc-shaped plate 11132.

During assembly, the gas distribution valve body 131 is first assembled and connected to the mounting valve base 132. Specifically, the gas distribution valve body 131 is provided with a third mounting hole 1313, and the mounting valve base 132 is formed with a fourth mounting hole 1324 at a position corresponding to the third mounting hole 1313. A chamber 1320 is formed inside the gas distribution valve body 131, which is in communication with a nitrogen discharge port of the gas distribution valve body 131. Then, the gas distribution valve 13 is assembled by fastening bolts through the third mounting hole 1313 and fourth mounting hole 1324. Correspondingly, the bottom of the mounting valve base 132 is also provided with a nitrogen discharge pipe 1321 that is in communication with the chamber 1320. A nitrogen discharge insertion hole 11123 is provided on the second bracket segment 1112. The nitrogen discharge pipe 1321 is inserted into the nitrogen discharge insertion hole 11123 for positioning and discharging exhaust gas to the second mounting region 116 below the second bracket segment 1112. The exhaust gas from the nitrogen discharge pipe 1321 is then discharged to the outside of the heat dissipation outlet 1130 through a flexible hose.

Then, a first mounting hole 11133 is provided on the connecting segment 1113. Specifically, the first mounting hole 11133 is provided on the strip plate 11131 of the connecting segment 1113, and two or more first mounting holes can be provided vertically. The mounting valve base 132 is provided with a second mounting hole 1323 at a position corresponding to the first mounting hole 11133. After the nitrogen discharge pipe 1321 is inserted into the nitrogen discharge insertion hole 11123 for positioning, the mounting valve base 132 is assembled and fixed to the connecting segment 1113 by bolts fastened through the first mounting hole 11133 and the second mounting hole 1323, thereby achieving the mounting of the gas distribution valve body 131 and the upper bracket 111. Depending on a size thereof, the mounting valve base 132 has at least one second fitting concave surface 1322 that fits the convex surface of the arc-shaped plate 11132 for fitting the convex surface of the arc-shaped plate 11132, so as to form a tight fit, thereby making the best use of the mounting space.

The entire gas distribution valve body 131 is positioned on the second bracket segment 1112. Specifically, a mounting region 11121 for the gas distribution valve 13 is formed on the second bracket segment 1112 near the connecting segment 1113. This mounting region 11121 can be shaped into a shallow groove area by means of a rib frame to limit and lock the gas distribution valve body 131. A limiting slot 11122 is also provided on the second bracket segment 1112. Specifically, the limiting slot 11122 is provided in the mounting region 11121. A limiting plate 1312 that is correspondingly inserted into and limited by the limiting slot 11122 is provided at the bottom of the gas distribution valve body 131 to facilitate the position limiting of the gas distribution valve body 131 on the second bracket segment 1112. Preferably, there are three limiting slots 11122 arranged side by side with spacing, and the number of limiting plates 1312 corresponds to that of the limiting slots 11122.

Furthermore, the gas distribution valve body 131 has one air inlet 1310 and two air outlets 1311. The air inlet 1310 is in communication with an air compressor of the oxygen concentrator, where compressed air is supplied. The gas distribution valve body 131 are then directly or indirectly in communication with the molecular sieve module 2 through the two air outlets 1311. Since the structural principle of the gas distribution valve 13 is a general technology in the related art, the structure of the gas distribution valve body 131 will not be further described. The gas distribution valve body 131 is preferably a two-position four-way solenoid valve.

Furthermore, the first bracket segment 1111 and the second bracket segment 1112 are both preferably plates, which are integrally formed with the connecting segment 1113. For the arc-shaped plate structure of the connecting segment 1113, the first bracket segment 1111 and the second bracket segment 1112 is formed with an arc-shaped structure at integrally formed connection portions thereof with the connecting segment 1113, which is adapted to match the connecting segment 1113.

With reference to FIGS. 3 and 4, the lower bracket 112 is mounted below the upper bracket 111 and is supported by the upper bracket 111. A heat dissipation port 1120 facing the quick-detach docking port 10 is also provided on the lower bracket 112. The heat dissipation port 1120 faces the molecular sieve module 2 (which is subsequently implemented to face the molecular sieve cylinder 24). When the temperature is low in winter, the heat dissipation port 1120 is opened, and heat dissipation gas of the compressor is transported to the molecular sieve cylinder 24 through the heat dissipation port 1120, which has effects of increasing a temperature of the molecular sieve on the inner side and enhancing the oxygen production efficiency of the molecular sieve.

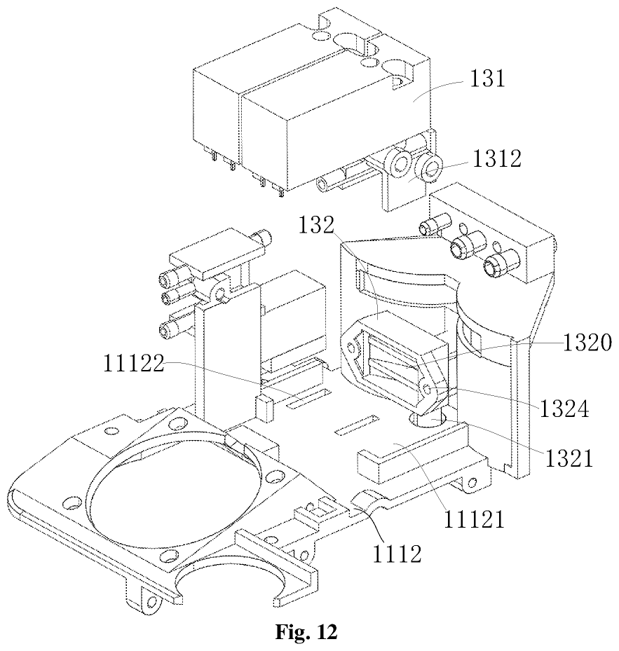

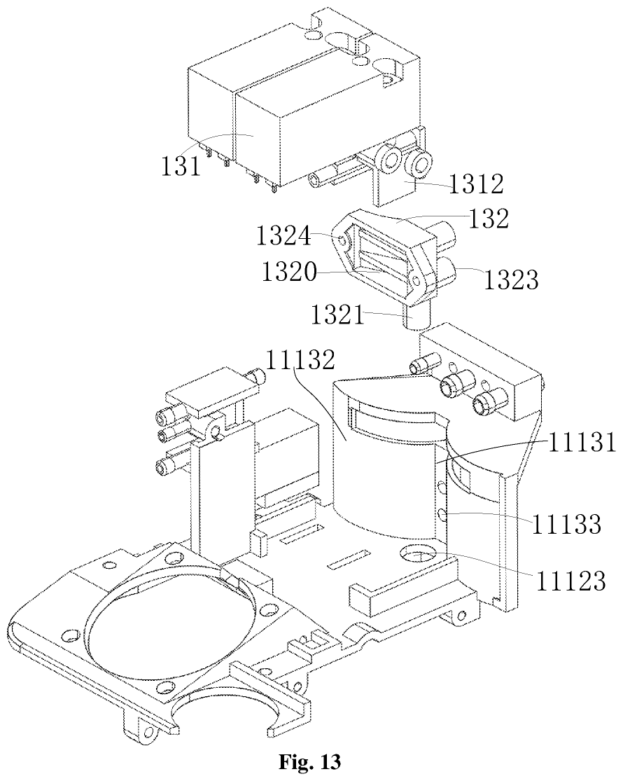

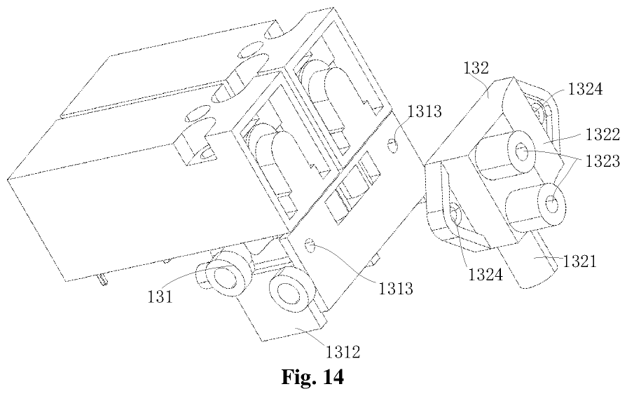

With reference to FIGS. 8 to 17, the molecular sieve module 2 has molecular sieve air inlet connectors 251, a molecular sieve oxygen connector 252, and a guide mating surface 260 disposed at a portion near a top. The molecular sieve air inlet connectors 251 are correspondingly inserted into the air inlet ports 121, and the molecular sieve oxygen connector 252 is correspondingly inserted into the oxygen port 122. The molecular sieve module 2 is assembled to the quick-detach docking port 10 of the oxygen concentrator main body 1 by guided fitting between the guide mating surface 260 and the guide wedge surface 1110 along an insertion direction.

The molecular sieve module 2 is connected to the first integrated docking support base 12 for gas exchange. The molecular sieve module 2 is mounted on the oxygen concentrator main body 1 in a detachable manner through an assembly structure.

In some embodiments, the molecular sieve module 2 includes an upper sieve lid 22, a lower sieve base 23, and two molecular sieve cylinders 24. The two molecular sieve cylinders 24 are mounted between the upper sieve lid 22 and the lower sieve base 23 and are positioned in the accommodating space. The molecular sieve air inlet connectors 251, molecular sieve oxygen connector 252 and guide mating surface 260 are provided on the upper sieve lid 22. The molecular sieve air inlet connectors 251 and the molecular sieve oxygen connector 252 are respectively in communication with an air inlet channel and an oxygen outlet channel of the molecular sieve cylinders 24.

Based on the oxygen production principle of the molecular sieve-type oxygen concentrator, the two molecular sieve cylinders 24 work alternately, and the two cylinders are in communication with the outside through exhaust channels in the upper sieve lid 22 and the lower sieve base 23. Furthermore, based on the structural principle of the molecular sieve cylinder 24 with air inlet at one end and oxygen outlet at the other end, the air inlet channel is positioned at the top of the molecular sieve cylinder 24, and the oxygen outlet channel is positioned at the bottom of the molecular sieve cylinder 24.

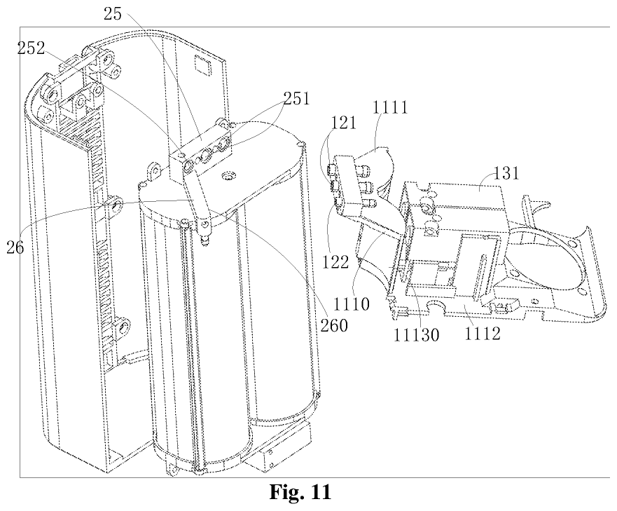

With reference to FIG. 10, a pressure equalization valve 230 is provided on the lower sieve base 23. The oxygen outlet channel is in communication with the outside through the pressure equalization valve 230. In some embodiments, the pressure equalization valve 230 is in communication with the molecular sieve oxygen connector 252, thereby integrating the air inlet and oxygen outlet of the molecular sieve on the upper sieve lid 22 at the top, achieving the overall quick-detach of the molecular sieve module 2, and reducing complex connection of pipelines. Furthermore, the upper sieve lid 22 is also provided with a gas guide extension pipe 26. One end of the gas guide extension pipe 26 is in communication with the molecular sieve oxygen connector 252, and the other end thereof extends and is suspended outside the molecular sieve cylinders 24 and in communication with the pressure equalization valve 230 through a flexible hose. Furthermore, referring to FIG. 11, the guide mating surface 260 is implemented as a side surface of the gas guide extension pipe 26.

With reference to FIGS. 8 and 10, the upper sieve lid 22 is fitted with the positioning slot 1114 in the oxygen concentrator main body 1. The upper sieve lid 22 is formed with at least one positioning insertion portion for inserting into the positioning slot 1114. Furthermore, the positioning insertion portion is implemented as a side edge of the upper sieve lid 22. When the molecular sieve module 2 is assembled to the oxygen concentrator main body 1, the upper sieve lid 22 is positioned in the positioning slot 1114, and the molecular sieve cylinder 24 is fitted with the first fitting concave surface 11130 of the upper bracket.

Furthermore, with reference to FIG. 10, the upper sieve lid 22 is provided with a second integrated docking support base 25 that is docked with the first integrated docking support base 12. The two molecular sieve air inlet connectors 251 and one molecular sieve oxygen connector 252 are provided on the second integrated docking support base 25. Furthermore, the first integrated docking support base 12 is provided with a first mounting hole 120, and the second integrated docking support base 25 is provided with a second assembly hole 250. When the two molecular sieve air inlet connectors 251 and one molecular sieve oxygen connector 252 are respectively inserted into the two air inlet ports 121 and one oxygen port 122, the first assembly hole 120 and the second assembly hole 250 align with each other, and these aligned holes allow for assembly with a screw passing therethrough. At least the first assembly hole 120 is positioned at an end position of the screw and is implemented as a threaded hole. Alternatively, both holes may be through holes, in which case a self-tapping screw is used.

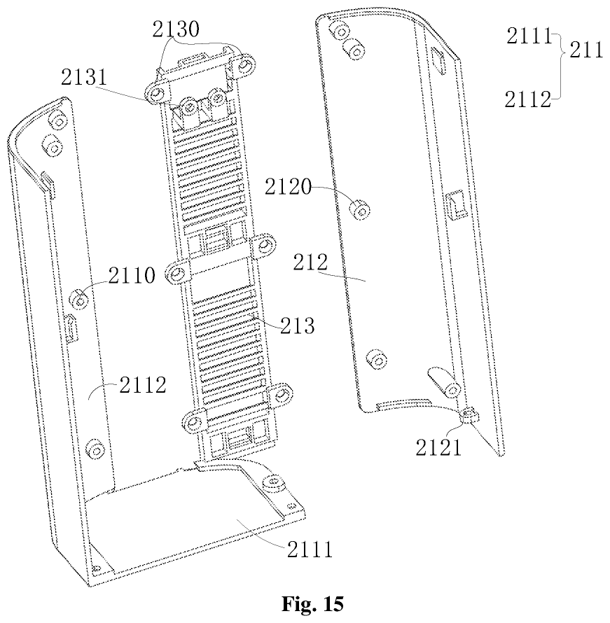

Furthermore, with reference to FIGS. 15 to 17, the molecular sieve module 2 also includes a molecular sieve shell 21. The molecular sieve shell 21 includes a first shell 211, a second shell 212, and an air inlet grille 213. Specifically, the air inlet grille 213 is assembled between the first shell 211 and the second shell 212. The air inlet grille 213 allows air to enter the air compression assembly 14 at least through mounting gaps of the quick-detach docking port 10 or the upper bracket 111 and the lower bracket 112. An air inlet filter is provided on an inner side and/or an outer side of the air inlet grille 213. In some embodiments, it is preferable that the air inlet filters are provided on both the inner side and the outer side of the air inlet grille 213.

The first shell 211 and the second shell 212 are respectively assembled to both sides of the air inlet grille 213. Specifically, air inlet grille assembly holes 2130 are provided on both sides of the air inlet grille 213. A first shell assembly hole 2110 is provided on a side near the air inlet grille 213 of the first shell 211, and a second shell assembly hole 2120 is provided on a side near the air inlet grille 213 of the second shell 212. The first shell assembly hole 2110 is assembled to the air inlet grille assembly hole 2130 on one side of the air inlet grille 213 with a screw, and the second shell assembly hole 2120 is assembled to the air inlet grille assembly hole 2130 on the other side of the air inlet grille 213 with a screw.

Furthermore, the first shell 211 includes a first bottom plate 2111 and a first vertical plate 2112. The second shell 212 is implemented as a second vertical plate. The first vertical plate 2112, a second vertical plate and the air inlet grille 213 form a U-shaped semi-enclosed structure. A bottom of the structure has the first bottom plate 2111, and a top thereof is an opening covered and hidden by the panel 114 of the oxygen concentrator main body 1. A side thereof is docked with the quick-detach docking port 10 to form a fully enclosed structure, while the upper sieve lid 22, the lower sieve base 23 and the molecular sieve cylinders 24 are provided therein.

Furthermore, with reference to FIGS. 8 and 15, a first lug 221 is provided on the upper sieve lid 22. The upper sieve lid 22 is mounted on the molecular sieve shell 21 through a screw passing through a hole of the first lug 221. A second lug 2121 is provided at a bottom of the second vertical plate. The second vertical plate is mounted on the molecular sieve shell 21 through a screw passing through a hole of the second lug 2121.

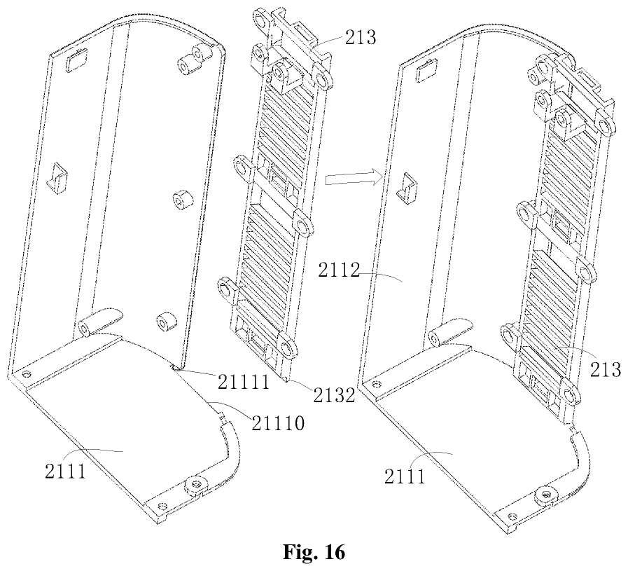

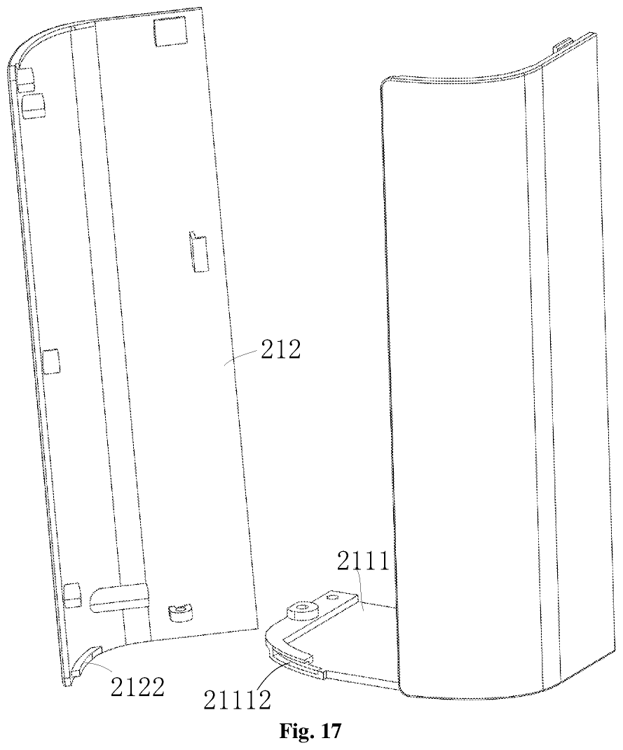

To facilitate the docking and assembly of the air inlet grille 213 and the second vertical plate with the first shell 211, with reference to FIGS. 16 and 17, in some embodiments, a first docking edge slot 21110 is provided on the first bottom plate, and a first clamping slot 21111 within the first docking edge slot 21110 is formed between the first docking edge slot 21110 and the first vertical plate 2112. A first docking portion 2132 is formed at a bottom of the air inlet grille 213, and the first docking portion 2132 is docked with the first docking edge slot 21110 and is partially clamped in the first clamping slot 21111. Furthermore, the first bottom plate 2111 is also provided with a first docking slot 21112, and a bottom of the second vertical plate is formed with a second docking portion 2122. The second docking portion 2122 is inserted into the first docking slot 21112. Preferably, the first docking portion 2132 is a rib formed at a bottom of the air inlet grille 213, and the second docking portion 2122 is a docking protrusion formed on the second shell 212.

After air enters through the air inlet grille 213, air is introduced through structural gaps between the upper bracket 111 and the lower bracket 112 inside the oxygen concentrator main body 1, so that air is filtered by the air inlet grille 213 and then enters the air compression assembly 14 in the second mounting region 116 for air compression. Then, the air is in communication with the air inlet 1310 of the gas distribution valve 13 through a flexible hose (not illustrated). Then, the air is in communication with the two air inlet ports 121 of the first integrated docking support base 12 through the two air outlets 1311 of the gas distribution valve 13. The two air inlet ports 121 are docked with the two molecular sieve air inlet connectors 251 of the molecular sieve module 2 to transport air to the molecular sieve cylinders 24. After oxygen separation in the molecular sieve cylinders 24, the oxygen returns to the first integrated docking support base 12 through the pressure equalization valve 230 of the lower sieve base 23 and the gas guide extension pipe 26. Then, the oxygen returns to the oxygen concentrator main body 1 through the molecular sieve oxygen connector 252 docked with the oxygen port 122. Finally, the oxygen enters the oxygen storage assembly 15 after passing through the oxygen injection valve 19 and the sensing assembly 16 as described above. The gas distribution valve 13, as a two-position four-way solenoid valve, can also backflush the molecular sieve cylinders 24 alternately through the air inlet ports 121 and the molecular sieve air inlet connector 251.

As described above, with reference to FIG. 10, the first assembly hole 120 and the second assembly hole 250 align with each other, and the two holes allow for assembly with a screw passing therethrough. To improve the assembly integrity of the molecular sieve shell 21, a third assembly hole is provided on the molecular sieve shell 21. The first assembly hole 120, the second assembly hole 250 and the third assembly hole allow for assembly with a screw passing therethrough. Furthermore, an air inlet grille lug 2131 is provided on the air inlet grille 213, and the third assembly hole is implemented as a lug hole on the air inlet grille lug 2131. The first assembly hole 120, the second assembly hole 250 and the third assembly hole together with a screw constitute a group. In some embodiments, two groups are preferred, and the two groups are arranged side by side.

It should be noted that in some embodiments, the air inlet ports 121, oxygen port 122 and guide wedge surface 1110 of the oxygen concentrator main body, and the molecular sieve air inlet connectors 251, molecular sieve oxygen connector 252 and guide mating surface 260 of the molecular sieve module 2 are preferably integrated near the panel 114, for matching a height of the molecular sieve cylinders. However, based on the expectations for the molecular sieve physical separation technique, the height of the molecular sieve cylinders is not limited in any way. The above connectors can also correspond to the middle position of the quick-detach docking port 10 of the oxygen concentrator 1 as the height of the molecular sieve cylinders decreases, and none of these are considered limitations of some embodiments.

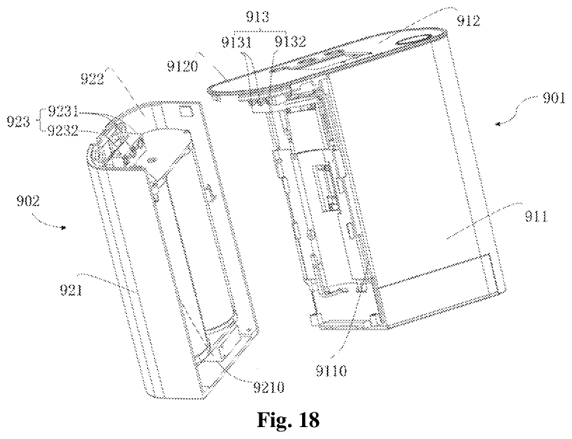

FIG. 18 is a schematic diagram of the oxygen concentrator in some embodiments. Referring to FIG. 18, some embodiments provide an oxygen concentrator, including an oxygen concentrator main body 901 and a molecular sieve module 902 that are assembled in a detachable manner.

The oxygen concentrator main body 901 includes: a first shell portion 911, a panel 912, and a main body connector portion 913. The first shell portion 911 is a portion including an upper bracket, a lower bracket, and a side plate, which is a part of a main body case.

The first shell portion 911 encloses to form a space capable of accommodating an air compression assembly, and is formed with a first assembly side portion 9110 on a side close to the molecular sieve module. The first assembly side portion 9110 is a portion that limits and forms a quick-detach docking port.

The panel 912 covers and is connected to one end of the first shell portion 911 and has a suspended extending portion 9120 that projects toward the molecular sieve module 902 relative to the first assembly side portion 9110, and the suspended extending portion 9120 is a portion of the panel that is suspended and extends over the quick-detach docking port.

The main body connector portion 913 is disposed between the suspended extending portion 9120 and the first assembly side portion 9110, and has an air inlet port 9131 and an oxygen port 9132.

The molecular sieve module 902 includes: a second shell portion 921 and a molecular sieve connector portion 923. The second shell portion 921 may be a molecular sieve shell.

The second shell portion 921 encloses to form a space capable of accommodating a molecular sieve cylinder, and is formed with a second assembly side portion 9210 on a side close to the oxygen concentrator main body 901, and one end of the second shell portion 921 is formed with an opening 922. The second assembly side portion 921 is a portion that mates with a docking socket.

The molecular sieve connector portion 923 is positioned within the space enclosed by the second shell portion 921, and has a molecular sieve air inlet connector 9231 and a molecular sieve oxygen connector 9232.

In an assembled state of the oxygen concentrator main body 901 and the molecular sieve module 902, the first assembly side portion 9110 and the second assembly side portion 9210 are connected to each other, the suspended extending portion 9120 covers the opening 922, the molecular sieve air inlet connector 9231 is correspondingly inserted into the air inlet port 9131, and the molecular sieve oxygen connector 9232 is correspondingly inserted into the oxygen port 9132.

Beneficial effects of some embodiments are as follows.

The present application makes molecular sieve replacement in a traditional oxygen concentrator more convenient and efficient by modularizing the molecular sieve and designing a quick-detach docking port. By integrating the air inlet and oxygen outlet mechanisms of the oxygen concentrator main body and the molecular sieve module, docking is performed using a pluggable assembly method, so as to shorten a replacement time of the molecular sieve module, improve user convenience in replacement, and enhance an overall integration level of the oxygen concentrator, making the device more compact and aesthetically pleasing.

A unique mounting structure is designed, in which the upper bracket is set as a staggered structure with high and low spaces. The molecular sieve cylinder is accommodated below the relatively high first bracket segment, and the gas distribution valve is disposed on the relatively low second bracket segment, so as to achieve a compact structural design, improve a space utilization rate, and facilitate the replacement and docking of the molecular sieve cylinder as a whole module.

The interfaces of the oxygen concentrator main body and the molecular sieve module, along with the gas distribution valve, are integrated into one area for convenient and efficient docking.

The specific design of the upper bracket, combined with the structures of the mounting valve base and the molecular sieve cylinders, ensures a tight fit between the molecular sieve cylinders, the upper bracket, and the gas distribution valve, further enhancing stability and ease of assembly of the device.

The gas distribution valve body is mounted on the connecting segment by the mounting valve base, and the bottom thereof is inserted into and limited by the second bracket segment. The mounting is carried out by positioning first and then assembling, which is stable and simple.

The nitrogen discharge insertion hole on the second bracket segment is for inserting the nitrogen discharge pipe of the mounting valve base, so that the exhaust gas of the gas distribution valve body can be discharged by this structure to a part below the upper bracket and then discharged to the outside of the oxygen concentrator. The nitrogen discharge insertion hole has the function of discharging nitrogen, and also enables mounting of the mounting valve base through the nitrogen discharge pipe.

By designing the molecular sieve shell and the molecular sieve cylinder into a modular structure, it is convenient for users to quickly perform replacement, thereby reducing a downtime and a maintenance cost of the oxygen concentrator and extending a service life thereof. Moreover, the molecular sieve shell is hidden under the panel, making the overall structure more aesthetically pleasing and integrated.

The modular design allows for quick detachment and mounting of the molecular sieve cylinders. By mounting the molecular sieve shell entirely in an assembly way, and after the assembly, fixing the molecular sieve shell via the slot, the overall detachment and assembly is facilitated.

To improve the ease of replacement of the molecular sieve: The molecular sieve module is designed with a quick-plug interface, making it easy for users to perform replacement or maintenance quickly.

To extend the service life of the device: The independent modular design ensures that the molecular sieve can be replaced in a timely manner, avoiding the overall device failure caused by the failure of the molecular sieve in a purely integrated design.

To improve maintenance efficiency: Quick docking and detachment simplify the maintenance process and reduce the maintenance cost of users.

An exemplary aspect of the present application provides an oxygen concentrator that allows a molecular sieve to be modularly attached and that has a high integration level.

Furthermore, the present application has been described in detail above with reference to the accompanying drawings and embodiments. Those skilled in the art can make various modifications to the present application based on the above description. Therefore, certain details in some embodiments should not be construed as limiting the present application, and the scope of protection of the present application shall be defined by the appended claims.

What is claimed is:

1. An oxygen concentrator assembled with a quick-detach molecular sieve, the oxygen concentrator comprising:
an oxygen concentrator main body having a quick-detach docking port formed on one side thereof, and an air inlet port, an oxygen port, and a guide wedge surface being integrated at a portion of the quick-detach docking port near a top, and the air inlet port, the oxygen port, and the guide wedge surface being disposed in a manner of projecting outward; and
a molecular sieve module provided with a molecular sieve air inlet connector, a molecular sieve oxygen connector, and a guide mating surface disposed at a portion of the molecular sieve module near a top, wherein
the molecular sieve module is assembled to the quick-detach docking port of the oxygen concentrator main body by guided fitting between the guide mating surface and the guide wedge surface along an insertion direction, and
the molecular sieve air inlet connector is correspondingly inserted into the air inlet port, and the molecular sieve oxygen connector is correspondingly inserted into the oxygen port.

2. The oxygen concentrator assembled with a quick-detach molecular sieve according to claim 1, wherein
the oxygen concentrator main body includes a main body case, and an air compression assembly, an oxygen storage assembly, a sensing assembly, and a control assembly disposed within the main body case,
the main body case includes an upper bracket, a lower bracket, a side plate, and a panel, and
the upper bracket and the lower bracket are disposed in different layers, the side plate encloses the upper bracket and the lower bracket and forms the quick-detach docking port on a side of the main body case, the panel is positioned above the side plate, and the air inlet port, the oxygen port, and the guide wedge surface are disposed on the upper bracket.

3. The oxygen concentrator assembled with a quick-detach molecular sieve according to claim 2, wherein
the upper bracket is further provided with a first integrated docking support base, and two air inlet ports and one oxygen port are disposed on the first integrated docking support base.

4. The oxygen concentrator assembled with a quick-detach molecular sieve according to claim 3, wherein
the upper bracket includes a first bracket segment having a high relative elevation, a second bracket segment having a low relative elevation, and a connecting segment that connects the first bracket segment and the second bracket segment, and
the first bracket segment extends over the quick-detach docking port, an accommodating space is formed below the first bracket segment, and the first integrated docking support base and the guide wedge surface are disposed on the first bracket segment.

5. The oxygen concentrator assembled with a quick-detach molecular sieve according to claim 4, wherein
the connecting segment includes one strip plate and two arc-shaped plates which are integrally formed, the strip plate is disposed between the two arc-shaped plates, and each of the arc-shaped plates has a first fitting concave surface facing the accommodating space.

6. The oxygen concentrator assembled with a quick-detach molecular sieve according to claim 5, wherein
the second bracket segment is provided with a gas distribution valve, the gas distribution valve includes a gas distribution valve body and a mounting base, the mounting base is assembled and fixed to the strip plate, the mounting base has a second fitting concave surface that fits a convex surface of the arc-shaped plate, an air inlet of the gas distribution valve body is in communication with the air compression assembly, and an air outlet of the gas distribution valve body is in communication with the air inlet port.

7. The oxygen concentrator assembled with a quick-detach molecular sieve according to claim 6, wherein
the mounting base has a chamber in communication with a nitrogen discharge port of the gas distribution valve body, a bottom of the mounting base is further provided with a nitrogen discharge pipe in communication with the chamber, and the second bracket segment is provided with a nitrogen discharge insertion hole, and the nitrogen discharge pipe is inserted into the nitrogen discharge insertion hole.

8. The oxygen concentrator assembled with a quick-detach molecular sieve according to claim 6, wherein
the second bracket segment is further provided with a limiting slot, and a bottom of the gas distribution valve body is provided with a limiting plate which is correspondingly inserted into and limited by the limiting slot.

9. The oxygen concentrator assembled with a quick-detach molecular sieve according to claim 5, wherein
the molecular sieve module includes an upper sieve lid, a lower sieve base, and two molecular sieve cylinders,
the molecular sieve cylinders are disposed between the upper sieve lid and the lower sieve base and positioned in the accommodating space, and the molecular sieve cylinders fit the first fitting concave surfaces, and
the molecular sieve air inlet connector, the molecular sieve oxygen connector, and the guide mating surface are provided on the upper sieve lid, and the molecular sieve air inlet connector and the molecular sieve oxygen connector are respectively in communication with an air inlet channel and an oxygen outlet channel of each of the molecular sieve cylinders.

10. The oxygen concentrator assembled with a quick-detach molecular sieve according to claim 9, wherein
the upper bracket is further provided with a positioning slot at a portion facing the upper sieve lid, and the upper sieve lid is formed with at least one positioning insertion portion inserted into the positioning slot.

11. The oxygen concentrator assembled with a quick-detach molecular sieve according to claim 9, wherein
the upper sieve lid is provided with a second integrated docking support base, and two molecular sieve air inlet connectors and one molecular sieve oxygen connector are disposed on the second integrated docking support base.

12. The oxygen concentrator assembled with a quick-detach molecular sieve according to claim 11, wherein
the oxygen outlet channel of the molecular sieve cylinder is positioned at a bottom, the lower sieve base is provided with a pressure equalization valve, and the oxygen outlet channel is in communication with the molecular sieve oxygen connector through the pressure equalization valve.

13. The oxygen concentrator assembled with a quick-detach molecular sieve according to claim 12, wherein
the upper sieve lid is further provided with a gas guide extension pipe, the gas guide extension pipe has one end in communication with the molecular sieve oxygen connector, and has the other end extending and suspended outside the molecular sieve cylinders and in communication with the pressure equalization valve through a flexible hose.

14. The oxygen concentrator assembled with a quick-detach molecular sieve according to claim 13, wherein
the guide mating surface is implemented as a side surface of the gas guide extension pipe.

15. The oxygen concentrator assembled with a quick-detach molecular sieve according to claim 11, wherein
the molecular sieve module further includes a molecular sieve shell, and the molecular sieve shell includes a first shell, a second shell, and an air inlet grille, and
the air inlet grille is assembled between the first shell and the second shell.

16. The oxygen concentrator assembled with a quick-detach molecular sieve according to claim 15, wherein
the lower bracket is provided with a heat dissipation port at a portion facing the quick-detach docking port, and the heat dissipation port faces the molecular sieve cylinder.

17. The oxygen concentrator assembled with a quick-detach molecular sieve according to claim 2, wherein
the panel is suspended and extends above the quick-detach docking port, and the molecular sieve module is hidden below the panel.

18. The oxygen concentrator assembled with a quick-detach molecular sieve according to claim 2, wherein
the control assembly is a control mainboard, and the sensing assembly includes an oxygen concentration sensor, a respiration sensor, and a pressure sensor disposed on the control mainboard, and
the control mainboard is disposed on the upper bracket and/or the lower bracket along a stacking direction of the upper bracket and the lower bracket.

19. The oxygen concentrator assembled with a quick-detach molecular sieve according to claim 2, wherein
the upper bracket is formed with a first mounting region, the lower bracket is formed with a second mounting region, the oxygen storage assembly is at least partially disposed in the first mounting region, and the air compression assembly is disposed in the second mounting region,
the respiration sensor and the pressure sensor are positioned in or face the first mounting region, and
the oxygen concentration sensor is positioned on a side of the control mainboard opposite the first mounting region, and an oxygen inlet pipe and an oxygen outlet pipe of the oxygen concentration sensor extend into the first mounting region.

20. An oxygen concentrator comprising:
an oxygen concentrator main body and a molecular sieve module that are assembled in a detachable manner, wherein
the oxygen concentrator main body includes
a first shell portion that encloses to form a space capable of accommodating an air compression assembly, and is formed with a first assembly side portion on a side close to the molecular sieve module,
a panel that covers and is connected to one end of the first shell portion and has a suspended extending portion projecting toward the molecular sieve module relative to the first assembly side portion, and
a main body connector portion that is disposed between the suspended extending portion and the first assembly side portion, and has an air inlet port and an oxygen port,
the molecular sieve module includes
a second shell portion that encloses to form a space capable of accommodating a molecular sieve cylinder, is formed with a second assembly side portion on a side close to the oxygen concentrator main body, and has one end formed with an opening, and
a molecular sieve connector portion that is positioned within the space enclosed by the second shell portion, and has a molecular sieve air inlet connector and a molecular sieve oxygen connector, and
in an assembled state of the oxygen concentrator main body and the molecular sieve module, the first assembly side portion and the second assembly side portion are connected to each other, the suspended extending portion covers the opening, the molecular sieve air inlet connector is correspondingly inserted into the air inlet port, and the molecular sieve oxygen connector is correspondingly inserted into the oxygen port.
